(19) United States
(12) Patent Application Publication
(10) Pub. No.: US 2006/0062492 A1
(43) Pub. Date: Mar. 23, 2006

(54) Document processing device, document processing method, and storage medium recording program therefor

(75) Inventors: Hiroshi Masuichi, Ashigarakami-gun (JP); Shaoming Liu, Ashigarakami-gun (JP); Michihiro Tamune, Ashigarakami-gun (JP); Masatoshi Tagawa, Ebina-shi (JP); Kiyoshi Tashiro, Kawasaki-shi (JP); Atsushi Itoh, Ashigarakami-gun (JP); Kyosuke Ishikawa, Minato-ku (JP); Naoko Sato, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/080,924

(22) Filed: Mar. 16, 2005

(30) Foreign Application Priority Data
Sep. 17, 2004 (JP) 2004-271734

(51) Int. Cl. G06K 9/54; H04N 1/00; G06K 9/00

(52) U.S. Cl. 382/305; 358/403; 382/181

(57) ABSTRACT

The invention provides a document processing device including: a memory that stores syntax data expressing syntax of character strings whose probability of being a title of a document is high or-character strings whose probability of being a title of a document is low; an input unit that inputs document data obtained by digitizing a document; an extraction unit that analyzes the input document data and extracts character string data expressing character strings; a syntax analyzing unit that analyzes the extracted character string data and specifies the syntax of each character string contained in the document corresponding to the document data; and a specifying unit that specifies, from among the extracted character string data, character string data expressing a title of the document corresponding to the document data, based on results of specification by the syntax analyzing unit and content stored in the memory.

This application claims priority under 35 U.S.C. §119 of Japanese Patent Application No. 2004-271734 filed on Sep. 16, 2004, the entire content of which is hereby incorporated by reference.

### BACKGROUND OF THE INVENTION

1. Field of the Invention

The present invention relates to technologies for digitizing paper documents, in particular technologies for specifying titles based on the content of the paper documents.

2. Description of Related Art

Paper documents (hereafter also referred to as “documents”) are an outstanding medium for transmitting and recording information, but entail problems including requiring spaces for storage such as archives. Furthermore, when information is recorded in paper documents and stored, if information recorded in those paper documents is later needed, the paper documents in which the desired information is recorded must be found among a large number of paper documents stored in archives and similar places. In other words, seen from the point of view of operational efficiency, recording and storing information in paper documents is not desirable.

On this background, it has become common to digitize and store paper documents. Specifically, it has become common to read images corresponding to pages in a paper document using a scanner or the like, convert image data corresponding to those images (hereafter, “document image data”) for each paper document into files, and store those files in storage devices such as hard disks.

When saving such files to hard disks or the like, it is convenient to store them after attaching a unique name to each file or to file them by classifying documents to be digitized by type, but in order to achieve this, it is necessary to accurately specify titles for the documents. This is because character strings including document titles are generally used as the names, and also because document titles in general accurately reflect the types of the documents. A number of technologies have been proposed which specify titles of documents based on the document image data and which correspond to the document image data. To describe this in more detail, it is known to provide a technology for specifying titles of documents based on image information surrounding character strings (i.e., image information expressing underlining attached to character strings and/or image information expressing distances from character strings positioned above and below).

Nevertheless, the technology disclosed above has the problems that the titles of documents are specified based on the presence or absence of formatting, such as underlining, which is unrelated to meaningful content of character strings contained in the paper documents to be digitized or based on the distance from other character strings, so that misjudgments occur easily, making it impossible to achieve a level of specifying precision high enough to be practicable.

The present invention was made in view of the above circumstances, and provides a technology which makes it possible to improve specifying precision when specifying titles of documents based on document data, obtained by digitizing documents.

### SUMMARY OF THE INVENTION

To address the problems described above, the present invention provides a document processing device which includes: a storage unit for storing syntax data which expresses syntax of character strings whose probability of being a title of a document is high or character strings whose probability of being a title of a document is low; an input unit into which document data obtained by digitizing a document is input; an extraction unit for analyzing document data input into the input unit and extracting character string data which expresses character strings; a syntax analysis unit for analyzing the character string data extracted by the extraction unit and specifying the syntax of each character string contained in the document corresponding to the document data; and a specifying unit for specifying, from among the character string data extracted by the extraction unit, character string data that expresses a title of the document corresponding to the document data, based on results of specification by the syntax analysis unit and content stored by the storage unit. With this document processing device and program, the title of a document is specified based on the syntax of each character string contained in the document which is processed.

### BRIEF DESCRIPTION OF THE DRAWINGS

Embodiments of the present invention will be described in detail based on the following figures, wherein:

FIG. 1 is a view showing an example of an overall configuration of a document digitizing system provided with a document processing device 110 according to a first embodiment of the present invention;

FIG. 2 is a view showing an example of a hardware configuration of the document processing device 110;

FIG. 3 is a view showing an example of a table format for a syntax table stored in a nonvolatile storage unit 220b on the document processing device 110;

FIG. 4 is a view showing an example of syntax of a character string with a low probability of being a title of a document;

FIG. 5 is a view showing an example of syntax of a character string with a high probability of being a title of a document;

FIG. 6 is a view showing an example of syntax of a character string with a high probability of being a title of a document;

FIG. 7 is a flowchart showing a flow of a paper document digitizing process which is performed by a control unit 200 on a document processing device 110 in accordance with paper document digitizing software;

FIG. 8 is a flowchart showing a flow of a paper document digitizing process according to a third variation;

FIG. 9 is a flowchart showing a flow of a paper document digitizing process according to the third variation.

### DETAILED DESCRIPTION OF THE INVENTION

Below is a description of embodiments according the present invention, with reference to the drawings.

A: Configuration

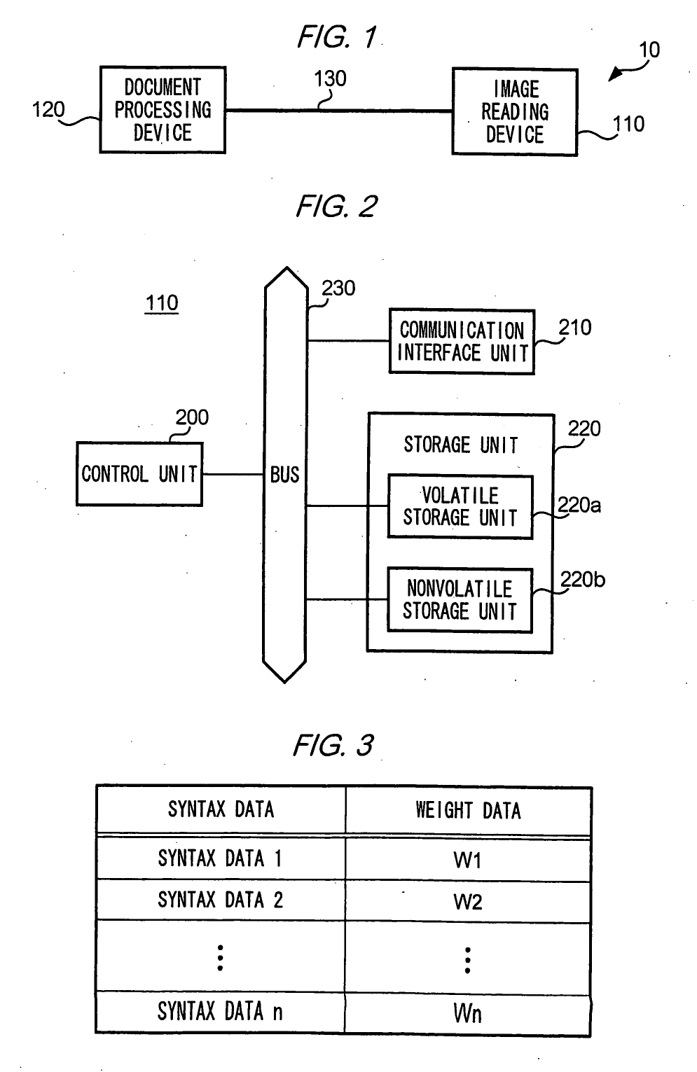

FIG. 1 is a block diagram showing an example of a configuration of a document digitizing system 10 provided with a document processing device 110 according to a first embodiment of the present invention. An image reading device 120 in FIG. 1 is, for example, a scanner device provided with an ADF (Auto Document Feeder) or other type of automatic paper feeding mechanism, which reads, one page at a time, paper documents set in the ADF, and passes document image data corresponding to read images to the document processing device 110 via a communication line 130, such as a LAN (Local Area Network). Note that while in the present embodiment a case is described wherein the communication line 130 is a LAN, this may of course encompass WANs (Wide Area Networks) or the Internet, etc. Note also that while in the present embodiment a case is described wherein the document processing device 110 and the image reading device 120 are configured as individual hardware components, both may of course be configured as a single hardware component. In such an embodiment, the communication line 130 is an internal bus connecting the document processing device 110 and the image reading device 120 inside relevant hardware.

The document processing device in FIG. 1, which converts document image data passed from the image reading device 120 into files, and stores and accommodates the files, is provided with a configuration shown in FIG. 2. As shown in FIG. 2, the document processing device 110 includes a control unit 200, a communications interface unit 210, a storage unit 220, and a bus 230, which intermediates transmission and reception of data among these constituent parts.

The control unit 200 is, for example, a CPU (Central Processing Unit), which controls various units of the document processing device 110 by executing various software programs stored in the storage unit 220 described below. The communications interface 210 is connected to the image reading device 120 via the communications line 130, and receives document image data sent from the image reading device 120 via the communications line 130 and passes it to control unit 200. In other words, the communications interface 210 functions as an inputting unit into which the document image data sent from the image reading device 120 is input.

As shown in FIG. 2, the storage unit 220 includes a volatile storage unit 220a and a nonvolatile storage unit 220b. The nonvolatile storage unit 220a is, for example, a RAM (Random Access Memory), and is used as a work area by the control unit 200 which operates in accordance with various software programs described below. In contrast, the nonvolatile storage unit 220b is, for example, a hard disk, which stores and accumulates the document image data, which have been converted into files. Data and software which allows the control unit 200 to realize functions specific to the document processing device 110 are stored in the nonvolatile storage unit 220b. Below is a description of data and software stored in the nonvolatile storage unit 220b.

One example of data stored in the nonvolatile storage unit 220b is data stored in a syntax table as shown in FIG. 3. This syntax table contains weight data which is associated with data expressing the syntax of is character strings (hereafter referred to as “syntax data”) and expresses the probability that a character string having that syntax is the title of a document. The content of the syntax table (i.e., syntax data and weight data associated with the syntax data) is used when specifying titles of documents corresponding to the document image data entered via the communication interface unit 210, based on the document image data. Below is a description of the syntax data and weight data.

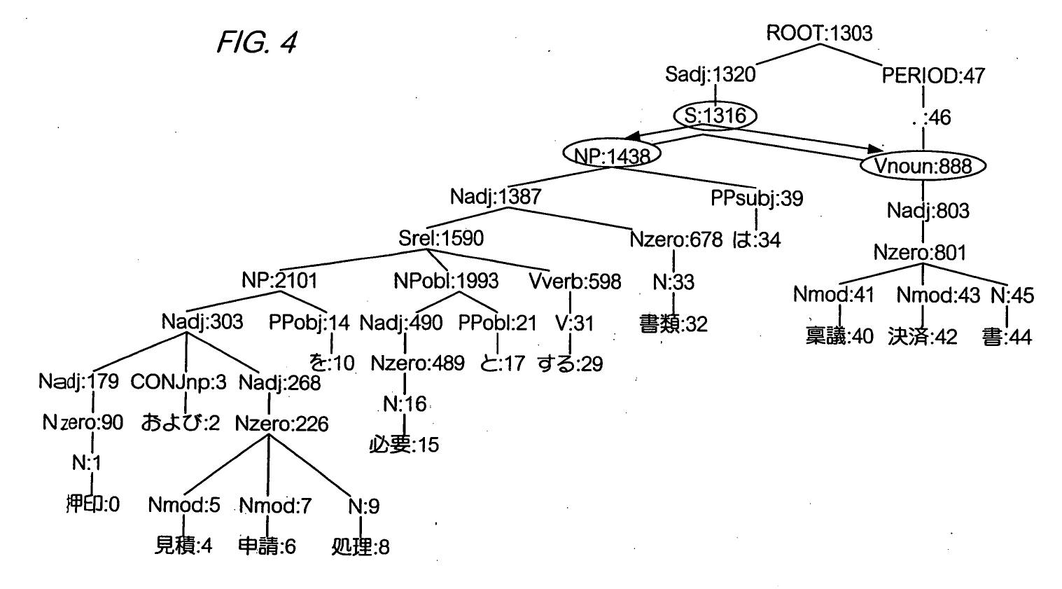

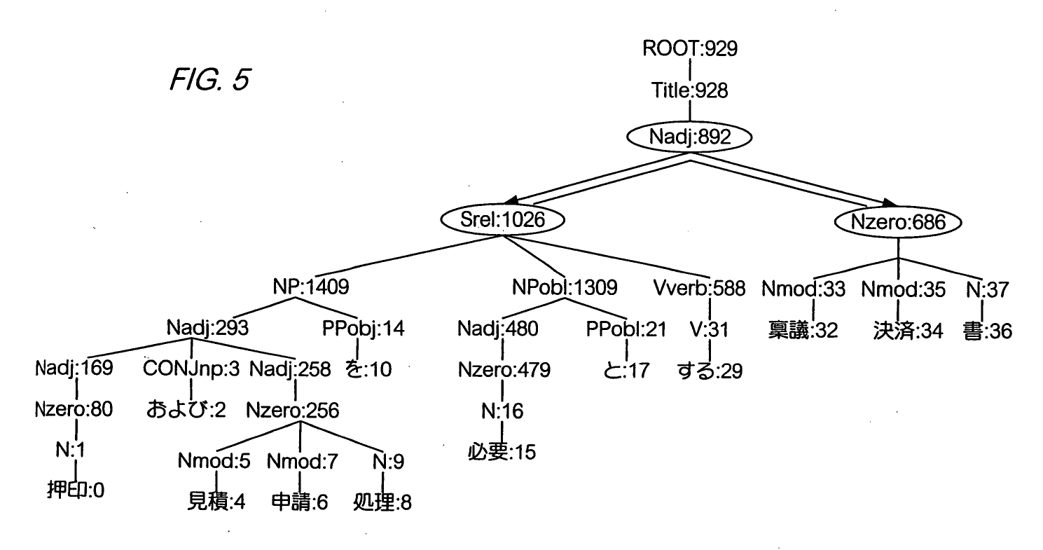

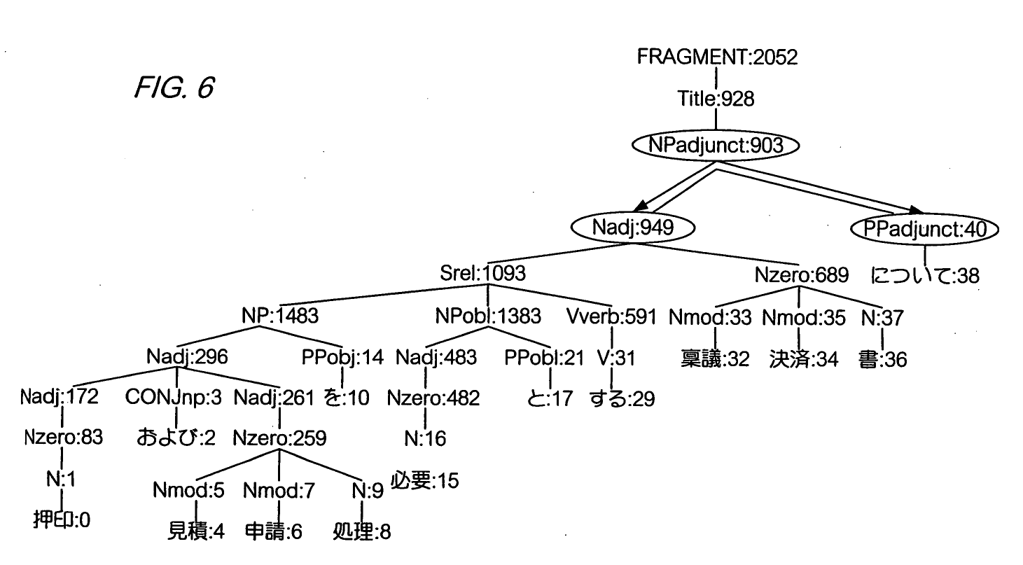

According to the present embodiment, the syntax data is data which expresses a tree structure as shown in FIG. 4, FIG. 5, and FIG. 6. FIG. 4 shows an example of a tree structure which expresses the syntax of a character string with a low probability of being the title of a document, while FIG. 5 and FIG. 6 both show examples of tree structures which express the syntax of character strings with a high probability of being titles of documents. Specifically, the tree structure shown in FIG. 4 expresses the syntax of the Japanese character string “ [symbol] [symbol] [symbol] [symbol] (The documents that require stamping and obtaining an estimate are the draft payment documents)”. The syntax indicated by the tree structure in FIG. 4 is entirely composed of a noun phrase (NP) and a predicate including a noun (Vnoun). Character strings possessing this syntax end with a noun, so they initially have the appearance of a title, but in actuality it is generally understood that the probability that they are the title of a document is low (although there is the possibility that they could be a title of a newspaper article, etc.). In contrast, the tree structure shown in FIG. 5 expresses the syntax of the character string “ [symbol] [symbol] [symbol] [symbol] (Draft payment documents that require stamping and obtaining an estimate)”, while the tree structure shown in FIG. 6 expresses the syntax of the character string “ [symbol] [symbol] [symbol] [symbol] [symbol] (Regarding draft payment documents that require stamping and is obtaining an estimate)”. The tree structure shown in FIG. 5 expresses a syntax entirely composed of a noun phrase (Nadj) modifying a noun (Nzero) with a relative clause (Srel), while the tree structure shown in FIG. 6 expresses a syntax entirely composed of a noun clause wherein a particle equivalent follow a noun phrase. It is generally understood that the syntax expressed by the tree structures shown in FIG. 5 and FIG. 6 has a high probability of being the title of a document. Note that in the present embodiment, a case is described wherein data expressing the syntax of a character string in a tree structure is used as the syntax data, but it is naturally also possible for the data to be in another format, as long as it can uniquely express the syntax.

On the other hand, the weight data associated with the syntax data and stored in the syntax table is data which is calculated in the following manner in the present embodiment. For plural character strings selected in advance (e.g., 100,000 character strings), a value of 1 is assigned if a character string is the title of a document, while a value of 0 is assigned if it is not the title of a document. The weight data is calculated by adding up these values for each syntax. In the present embodiment a case is described wherein, as the weight data, values are used that are the result of adding up the number of character strings which are titles of a document for each syntax, from among plural character strings selected in advance, although in essence, this may be any kind of data, as long as it expresses the probability that a character string with the syntax expressed by the syntax data is the title of a document.

Examples of the software stored in the nonvolatile storage unit 220b include operating system (“OS”) software, which allows the control unit 200 to realize an OS, and paper document digitizing software. In the present context, paper document digitizing software is taken to mean software which lets the control unit 200 execute a process wherein the document image data is stored after having a filename attached to it in accordance with the title of the document corresponding to the document image data, when converting the document image data into a file and storing the file in the nonvolatile storage unit 220b. Below is a description of functions provided to the control unit 200 by execution of this software.

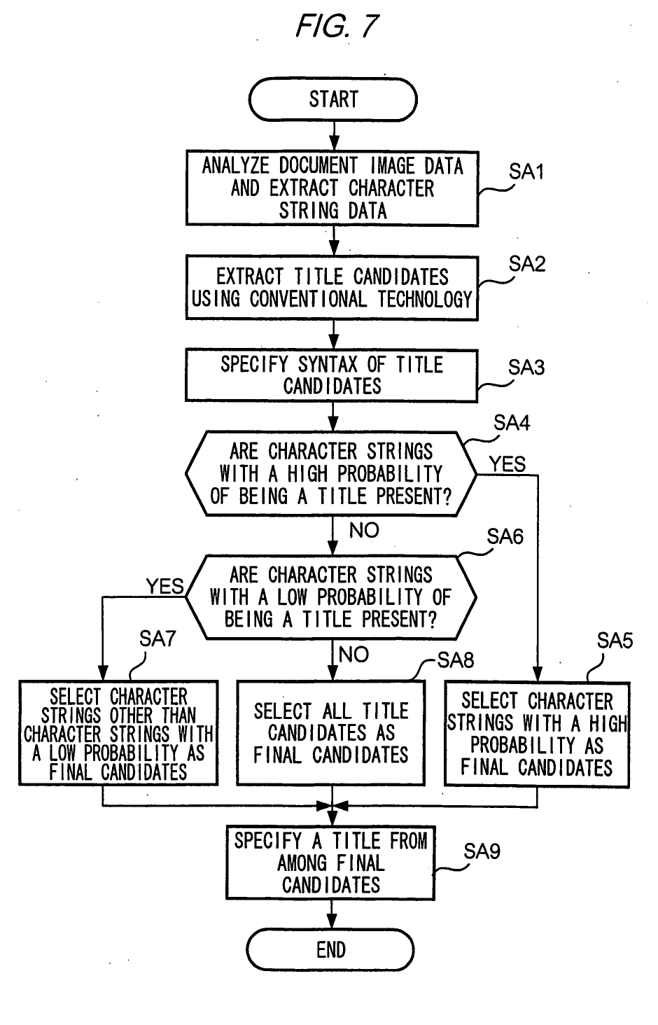

When the electric power source (not illustrated) of the document processing device 110 is turned on, the control unit 200 first reads the OS software from the nonvolatile storage unit 220b and executes it. When operating according to the OS software and realizing an OS, the control unit 200 is provided with functions to control various units of the document processing device 110, functions to read other software from the nonvolatile storage unit 220b and execute it, and so on. According to the present embodiment, as soon as execution of the OS software is complete and the OS is being realized, the control unit 200 reads the paper document digitizing software from the nonvolatile storage unit 220b and executes it. FIG. 7 is a flowchart showing a flow of a paper document digitizing process which is performed by the control unit 200 operating in accordance with the paper document digitizing software. As shown in FIG. 7, the three functions described below are provided to the control unit 200 operating in accordance with the paper document digitizing software.

First is an extraction function for analyzing document image data when it is read in via the communication interface unit 210 (i.e., document image data corresponding to the paper document being processed) and extracting character string data which expresses character strings. Details are described below, but according to the present embodiment, this extraction function extracts character string data corresponding to character strings judged to have a probability of being a title, based on the presence or absence of underlining and/or its position relative to other character strings (i.e., based on conventional technology.) Second is a syntax analysis function for analyzing all character string data extracted by the extraction function and specifying the syntax for every character string contained in the paper document corresponding to the document image data. Third is a specifying function for specifying character string data expressing the title of the document from the character string data extracted by the extraction function, based on the syntax of each character string specified by the syntax analysis function and the content of the syntax table.

As described above, the hardware configuration of the document processing device 110 according to the present embodiment is identical to that of common computer devices, and operation of the control unit 200 in accordance with various software programs stored in the nonvolatile storage unit 220b realizes functions specific to the document processing device according to the embodiment of the present invention. Accordingly, while in the present embodiment a case has been described in which software modules realize functions specific to the document processing device according the present invention, it is also possible to configure the document processing device according the present invention using hardware modules which provide these functions. Specifically, it is also possible to configure a document processing device according the present invention by providing an extraction unit which fulfills the extraction function, a syntax analysis unit which fulfills the syntax analysis function, and a specifying unit which fulfills the specifying function, each as a hardware module, to the document processing device, which has an input unit for reading in document image data from an image reading device 120 and a storage unit in which the syntax table is stored, combining the hardware modules such that they operate in a linked fashion in accordance with the flowchart shown in FIG. 7.

B: Operation

Next follows a description of those operations which exemplify the features of a document processing device 110, with reference to the drawings.

First, when a user sets a paper document on the ADF of the image reading device 120 and performs a predetermined operation (e.g., pressing a start button provided on an operating unit of the image reading device 120), images corresponding to pages in the paper document are read by the image reading device 120 and document image data corresponding to the images of the pages is sent to the document processing device 110 from the image reading device 120 via the communications line 130.

On the other hand, when the document image data is input via a communications interface 210, the control unit 200 of the document processing device 110 stores the document image data by writing it to the volatile storage unit 220a. The control unit 200 then performs the paper document digitizing in according to the flowchart shown in FIG. 7 on the document image data accumulated in the nonvolatile storage unit 220a, specifies the title for the paper document which corresponds to the document image data, associates it with a filename including the title, writes it to the nonvolatile storage unit 220b, and completes the digitizing process. Below is a description of operations performed by the control unit 200, with reference to FIG. 7.

FIG. 7 is a flowchart showing a flow of the paper document digitizing process performed by the control unit 200. As shown in FIG. 7, the control unit 200 first analyzes the document image data accumulated in the volatile storage unit 220a and for every character string extracts character string data expressing character strings in the document corresponding to the document image data and property data which expresses whether the character string is underlined and the distance of the character string from character strings above and below it (step SA1). Specifically, the control unit 200 extracts from the document image data a data block corresponding to an image in an area containing character strings, and extracts the character string data and property data using OCR (Optical Character Recognition) on the image that corresponds to that data block.

Next, using conventional technology, the control unit 200 extracts character string data for character strings that are title candidates from the character string data extracted in step SA1 (step SA2), based on the property data corresponding to the character string data. Specifically, based on the property data extracted in step SA1, the control unit 200 specifies whether the character strings represented by the character string data corresponding to the property data is underlined, while also specifying the distance between those character strings and the character strings above and below them. The control unit 200 then extracts as title candidates character string data corresponding to character strings which are underlined and to which that distance is larger than a predetermined value.

In step SA3 which follows step SA2, the control unit 200 performs syntax analysis on all the character string data for the title candidates extracted in step SA2, and specifies the syntax of the character strings corresponding to that character string data. Specifically, the control unit 200 performs syntax analysis on all the character string data for the title candidates narrowed down in step SA2, generates the syntax data described above, and specifies the syntax of the character strings expressed by the character string data. Next, based on the specification results and the content stored in the syntax table from step SA3, the control unit 200 judges whether the character string data for the title candidates extracted in step SA2 contains character string data corresponding to character strings with a high probability of being titles (step SA4). To describe this in more detail, the control unit 200 makes a judgment for all character string data extracted in step SA2 regarding whether the value of the weight data stored in the syntax table in association with the syntax data generated for the corresponding character string data in step SA3 is larger than the predetermined first threshold value. If there is even one instance of character string data for which the result of the judgment is “Yes,” then the control unit 200 judges that the title candidates narrowed down in step SA2 include character string data corresponding to character strings with a high probability of being titles.

If the result of the judgment in step SA4 is “Yes,” the control unit 200 selects the character string data corresponding to the character strings judged to have a high probability of being a title in step SA4 above as the final candidates for the title of the document corresponding to the document image data (step SA5). In contrast, if the result of the judgment in step SA4 is “No,” then based on the specification results and the content stored in the syntax table from step SA3, the control unit 200 judges whether the character string data for the title candidates extracted in step SA2 contains character string data corresponding to character strings with a low probability of being titles (step SA6). To describe this in more detail, the control unit 200 makes a judgment for all character string data extracted in step SA2 regarding whether the value of the weight data stored in the syntax table in association with the syntax data generated for the corresponding character string data in step SA3 is smaller than the predetermined second threshold value. If there is even one instance of character string data for which the result of the judgment is “Yes,” then the control unit 200 judges that the title candidates include character string data corresponding to character strings with a low probability of being titles. Furthermore, the second threshold value can be any value as long as it is equal to the first threshold value or smaller than the first threshold value.

If the result of the judgment in step SA6 is “Yes,” then the control unit 200 deletes the character string data corresponding to the character strings judged to have a low probability of being titles in step SA6 above from the character string data narrowed down in step SA6 and selects the remaining character string data as the final candidates for the title of the document (step SA7). In contrast, if the result of the judgment in step SA6 is “No,” the control unit 200 selects all the character string data of the title candidates extracted in step SA2 as the final candidates for character strings expressing the title of the document (step SA8).

In step SA9, which is executed following step SA5, step SA7, or step SA8, the control unit 200 specifies character string data expressing the character string selected as the title of the document from among the character string data for the final candidates (step SA9). Specifically, if there is only one instance of character string data for the final candidate, the control unit 200 specifies the character string expressed by that character string data as the title, whereas if there is plural instances of character string data for the final candidates, the control unit 200 specifies the character string expressed by the character string data with the highest probability of being the title as the title of the document (i.e., the character string data with the syntax expressed by the syntax data associated with the weight data that has the highest value). Needless to say, it is also possible to present the user with plural character strings if there is plural instances of character string data for the final candidates, and specify as the title of the document a character string selected by the user. After this, the control unit 200 attaches a name corresponding to the title specified in step SA9, writes the document image data to the nonvolatile storage unit 220b, and terminates the paper document digitizing process.

As described above, with the document processing device 110 according to the present embodiment, when specifying the title of a document to be digitized, character strings for title candidates are narrowed down based on conventional technology from among character strings contained in the document, after which a character string is specified as the title of the document after narrowing down further based on the syntax of the character strings. This has the effect of making it possible to specify titles with greater precision than previously. Furthermore, in the present embodiment a case was described in which a title of a document is specified which corresponds to document image data input into the document processing device 110 and a filename is attached in accordance with the title and written to a storage unit provided to the document processing device 110. However, it is of course possible to associate the document image data and name data expressing the filename and store them in a storage device separate from the document processing device 110 by associating them and sending them to the storage device.

C. Variations

The above was a detailed description of an embodiment of the present invention, but it is of course possible to add the variations described below.

C-1. First Variation

In the embodiment above, a case was described in which a title of a paper document is specified based on document image data corresponding to an image of the paper document. However, it is of course also possible to specify the title of a document based on data corresponding to a document created on a word processor or other device (i.e., data in which for example character codes for characters in the document and line feed codes are arranged in order: hereafter referred to as “code data”). That is to say, as long as the document data corresponds to a paper document, it may be image data or code data.

C-2. Second Variation

In the above embodiment, character strings that are title candidates are narrowed down from character string data read from document image data using conventional technology (i.e., technology which specifies character strings which are titles based on whether the character strings expressed by the character string data are underlined, and the distance of the character strings from character strings above and below), after which the syntax of the narrowed-down character strings is analyzed, and a character string which is the title of the document corresponding to the document image data is further narrowed down based on the results of the analysis and content stored in a syntax table. However, it is also of course possible to narrow down a final candidate by narrowing down using conventional technology after narrowing down the character string data based on the syntax. Furthermore, in the embodiment above, as an example of narrowing down using conventional technology, a case was described in which narrowing down of title candidates is performed based on the presence or absence of underlining and distances from character strings above and below, but it is also of course possible to narrow down based on only one of these or based on the types of font of the character strings and the sizes of the font. Moreover, it is also of course possible to analyze the syntax of character strings expressed by all the character string data read from the document image data and narrow down the title candidates for a document corresponding to the document image data based on the results of the analysis and the content stored in the syntax table, without narrowing down using conventional technology (in other words, to perform step SA3 immediately after step SA1, without performing step SA2, shown in FIG. 7).

C-3. Third Variation

In the above embodiment, a case was described in which syntax data expressing the syntax of character strings is associated with weight data expressing the probability that a character string with that syntax is a title of a document, and syntax data expressing syntax with a high probability of being a title and syntax data expressing syntax with a low probability of being a title are stored in a syntax table. However, it is also possible to store only syntax data expressing syntax with a high probability of being a title in the syntax table, and it is also possible, in contrast, to store only syntax data expressing syntax with a low probability of being a title in the syntax table. Moreover, if only syntax data expressing syntax with a low (or high) probability of being a title of a document is stored in the syntax table, there is no need to associate the weight data with the syntax data.

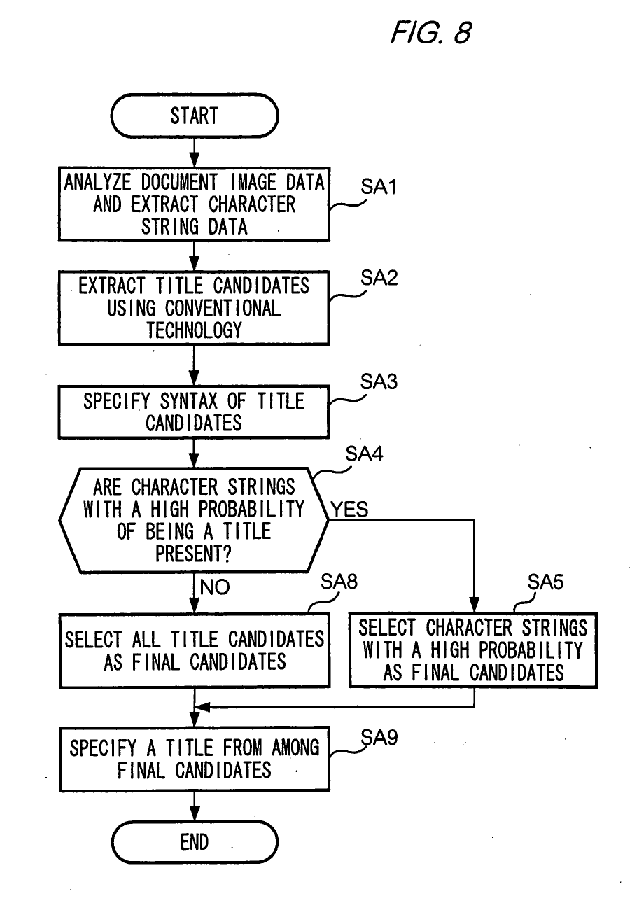

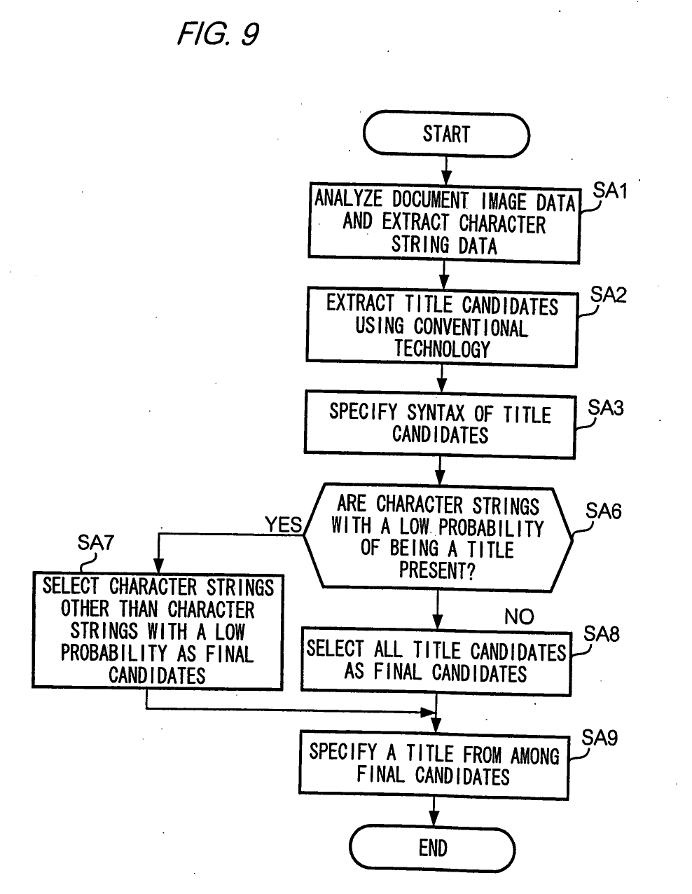

For example, if only syntax data expressing syntax with a high probability of being a title of a document is stored in the syntax table, a paper document digitizing process as shown in FIG. 8 should be executed instead of the paper document digitizing process shown in FIG. 7. The paper document digitizing process shown in FIG. 8 differs from the paper document digitizing process shown in FIG. 7 only in that the process in step SA8 is unconditionally performed if the result of the judgment in step SA4 is “No.” Furthermore, if only syntax data expressing syntax with a low probability of being a title of a document is stored in the syntax table, then a paper document digitizing process as shown in FIG. 9 should be executed instead of the paper document digitizing process shown in FIG. 7. The paper document digitizing process shown in FIG. 9 differs from the paper document digitizing process shown in FIG. 7 only in that the process in step SA6 is performed after step SA3.

C-4. Fourth Variation

In the embodiment described above, a case was described wherein software for making the control unit 200 realize functions specific to a document processing device according the present invention is stored beforehand in the nonvolatile storage unit 220. However, it is also of course possible to store the software in a storage medium which is readable by a computer, such as CD-ROM (Compact Disk-Read Only Memory) and DVD (Digital Versatile Disk), and install the software in a general computer device using this storage medium. This has the effect of making it possible to make a general computer device functions as a document processing device according the present invention.

As described above, the present invention provides a document processing device which includes: a memory that stores syntax data which expresses syntax of character strings whose probability of being a title of a document is high or character strings whose probability of being a title of a document is low; an input unit that inputs document data obtained by digitizing a document; an extraction unit that analyzes document data input by the input unit and extracts character string data which expresses character strings; a syntax analyzing unit that analyzes the character string data extracted by the extraction unit and specifies the syntax of each character string contained in the document corresponding to the document data; and a specifying unit that specifies, from among the character string data extracted by the extraction unit, character string data that expresses a title of the document corresponding to the document data, based on results of specification by the syntax analyzing unit and content stored in the memory. With this document processing device and program, the title of a document is specified based on the syntax of each character string contained in the document which is processed.

According to an embodiment of the invention, weight data expressing levels of probability that a character string with syntax expressed by the syntax data is the title of a document, is associated with the syntax data stored in the memory, and the specifying unit specifies the character string data expressing the title of the document based on the weight data stored in the memory in association with the syntax data expressing the syntax specified by the syntax analyzing unit. With this embodiment, it is possible to specify as titles of the documents being processed character strings, whose syntax indicates the highest probability of being titles of documents.

According to another embodiment of the invention, the specifying unit narrows down the character string data extracted by the extraction unit to character string data with a probability of being the title of a document, in accordance with the result of specification by the syntax analyzing unit and content stored in the memory, presents a user with this narrowed-down character string data, and specifies character string data selected by the user as the character string data expressing the title of the document. With this embodiment, the title of the document is specified from among title candidates narrowed down based on the syntax of character strings contained in the document. This embodiment is particularly applicable in cases, in which there is plural character strings having a syntax indicating a high possibility of being a title of a document and wherein there is not a large difference in the levels of probability.

According to another embodiment of the invention, the specifying unit deletes, from the character string data extracted by the extraction unit, character string data that has a low probability of being the title of a document, in accordance with the result of specification by the syntax analyzing unit and content stored in the memory, presents a user with the remaining character string data, and specifies character string data selected by the user as the character string data expressing the title of the document. With this embodiment, the title of the document is specified from among title candidates from which character strings with a low probability of being a title of a document have been eliminated.

According to another embodiment of the invention, the extraction unit extracts, from among the document data obtained by analyzing the document data input by the input unit, only character string data that expresses character strings with a high probability of being a title of the document corresponding to the document data, depending on the presence or absence of formatting of the character strings corresponding to this character string data or based on distances from character strings positioned above or below those character strings. With this embodiment, titles of documents are narrowed down based on their syntax from among title candidates which are narrowed down based on how the character strings are formatted or their distances from character strings above and below.

Also, the present invention provides a document processing method including: storing in a memory, syntax data which expresses syntax of character strings whose probability of being a title of a document is high or character strings whose probability of being a title of a document is low; inputting document data obtained by digitizing a document; extracting character string data which expresses character strings by analyzing the input document data; specifying a syntax of each character string contained in the document corresponding to the document data by analyzing the extracted character string data; and specifying, from among the extracted character string data, character string data that expresses a title of the document corresponding to the document data, based on a result of the specification and content stored in the memory.

According to an embodiment of the invention, weight data expressing levels of probability that a character string with syntax expressed by the syntax data is the title of a document, is associated with the syntax data stored in the memory, and the character string data specifying step includes specifying the character string data expressing the title of the document based on the weight data stored in the memory in association with the syntax data expressing the specified syntax.

According to another embodiment of the invention, the character string data specifying step includes: narrowing down the extracted character string data to character string data with a probability of being the title of a document, in accordance with a result of the specification and content stored in the memory; presenting a user with the narrowed-down character string data; and specifying character string data selected by the user as the character string data expressing the title of the document.

According to another embodiment of the invention, the character string data specifying step includes: deleting, from the extracted character string data, character string data that has a low probability of being the title of a document, in accordance with a result of the specification and content stored in the memory; presenting a user with remaining character string data; specifying character string data selected by the user as the character string data expressing the title of the document.

According to another embodiment of the invention, the extraction unit includes extracting, from among the document data obtained by analyzing the input document data, only character string data that expresses character strings with a high probability of being a title of the document corresponding to the document data, depending on a presence or absence of formatting of the character strings corresponding to this character string data or based on distances from character strings positioned above or below those character strings.

Also, the present invention provides a computer-readable storage medium recording a program for causing a computer to function as: an extraction unit that, when document data obtained by digitizing a document is input, analyzes the document data and extracts character string data expressing character strings; a syntax analysis unit for analyzing the character string data extracted by the extraction unit and specifying the syntax of each character string contained in the document corresponding to the document data; and a specifying unit for specifying, from among the character string data extracted by the extraction unit, character string data that expresses a title of the document corresponding to the document data, based on results of specification by the syntax analysis unit and syntax data stored in advance in the computer as data expressing the syntax of character strings whose probability of being a title of a document is high or character strings whose probability of being a title of a document is low. With the computer-readable storage medium, the title of a document is specified based on the syntax of each character string contained in the document which is processed.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described to best explain the principles of the invention and its practical applications, to thereby enable others skilled in the art to understand various embodiments of the invention and various modifications thereof, to suit a particular contemplated use. It is intended that the scope of the invention be defined by the following claims and their equivalents.

1. A document processing device comprising:
a memory that stores syntax data which expresses syntax of character strings whose probability of being a title of a document is high or character strings whose probability of being a title of a document is low;
an input unit that inputs document data obtained by digitizing a document;
an extraction unit that analyzes document data input by the input unit and extracts character string data which expresses character strings;
syntax analyzing unit that analyzes the character string data extracted by the extraction unit and specifies the syntax of each character string contained in the document corresponding to the document data; and
specifying unit that specifies, from among the character string data extracted by the extraction unit, character string data that expresses a title of the document corresponding to the document data, based on results of specification by the syntax analyzing unit and content stored in the memory.

2. The document processing device according to claim 1,
wherein weight data expressing levels of probability that a character string with syntax expressed by the syntax data is the title of a document, is associated with the syntax data stored in the memory, and
wherein the specifying unit specifies the character string data expressing the title of the document based on the weight data stored in the memory in association with the syntax data expressing the syntax specified by the syntax analyzing unit.

3. The document processing device according to claim 2, wherein the specifying unit narrows down the character string data extracted by the extraction unit to character string data with a probability of being the title of a document, in accordance with the result of specification by the syntax analyzing unit and content stored in the memory, presents a user with this narrowed-down character string data, and specifies character string data selected by the user as the character string data expressing the title of the document.

4. The document processing device according to claim 2, wherein the specifying unit deletes, from the character string data extracted by the extraction unit, character string data that has a low probability of being the title of a document, in accordance with the result of specification by the syntax analyzing unit and content stored in the memory, presents a user with the remaining character string data, and specifies character string data selected by the user as the character string data expressing the title of the document.

5. The document processing device according to claim 1, wherein the extraction unit extracts, from among the document data obtained by analyzing the document data input by the input unit, only character string data that expresses character strings with a high probability of being a title of the document corresponding to the document data, depending on the presence or absence of formatting of the character strings corresponding to this character string data or based on distances from character strings positioned above or below those character strings.

6. A document processing method comprising:
storing in a memory, syntax data which expresses syntax of character strings whose probability of being a title of a document is high or character strings whose probability of being a title of a document is low;
inputting document data obtained by digitizing a document;
extracting character string data which expresses character strings by analyzing the input document data;
specifying a syntax of each character string contained in the document corresponding to the document data by analyzing the extracted character string data; and
specifying, from among the extracted character string data, character string data that expresses a title of the document corresponding to the document data, based on a result of the specification and content stored in the memory.

7. The document processing method according to claim 6,
wherein weight data expressing levels of probability that a character string with syntax expressed by the syntax data is the title of a document, is associated with the syntax data stored in the memory, and
wherein the character string data specifying step includes specifying the character string data expressing the title of the document based on the weight data stored in the memory in association with the syntax data expressing the specified syntax.

8. The document processing method according to claim 7, wherein the character string data specifying step includes:
narrowing down the extracted character string data to character string data with a probability of being the title of a document, in accordance with a result of the specification and content stored in the memory;
presenting a user with the narrowed-down character string data; and
specifying character string data selected by the user as the character string data expressing the title of the document.

9. The document processing method according to claim 7, wherein the character string data specifying step includes:
deleting, from the extracted character string data, character string data that has a low probability of being the title of a document, in accordance with a result of the specification and content stored in the memory;
presenting a user with remaining character string data;
specifying character string data selected by the user as the character string data expressing the title of the document.

10. The document processing method according to claim 6, wherein the extraction step includes extracting, from among the document data obtained by analyzing the input document data, only character string data that expresses character strings with a high probability of being a title of the document corresponding to the document data, depending on a presence or absence of formatting of the character strings corresponding to this character string data or based on distances from character strings positioned above or below those character strings.

11. A computer-readable storage medium recording a program for causing a computer to function as:
extraction means that, when document data obtained by digitizing a document is input, analyzes the document data and extracts character string data expressing character strings;
syntax analysis means for analyzing the character string data extracted by the extraction means and specifying the syntax of each character string contained in the document corresponding to the document data; and
specifying means for specifying, from among the character string data extracted by the extraction means, character string data that expresses a title of the document corresponding to the document data, based on results of specification by the syntax analysis means and syntax data stored in advance in the computer as data expressing the syntax of character strings whose probability of being a title of a document is high or character strings whose probability of being a title of a document is low.
